(19) United States
(12) Patent Application Publication
(10) Pub. No.: US 2016/0037481 A1
(43) Pub. Date: Feb. 4, 2016

(54) Rich Notifications

(71) Applicant: Microsoft Technology Licensing, LLC, Redmond, WA (US)

(72) Inventors: Sung Joon Won, Seattle, WA (US); Jiwon Choi, Seattle, WA (US); Justin Chung-ting Lam, Bellevue, WA (US); Kyle Thomas Kral, Duvall, WA (US); Travis Jay Popkave, Seattle, WA (US)

(73) Assignee: Microsoft Technology Licensing, LLC, Redmond, WA (US)

(21) Appl. No.: 14/447,262

(22) Filed: Jul. 30, 2014

(51) Int. Cl. H04W 68/00; H04M 1/67; G06F 3/0488; H04M 1/725

(52) U.S. Cl. CPC H04W 68/00; H04M 1/72522; H04M 1/72569; H04M 1/67; G06F 3/04883

(57) ABSTRACT

Various embodiments provide notifications with respect to various communications that are visually embellished to indicate a perceived importance of the communication based upon one or more criteria. In addition, in at least some embodiments, multiple different types of notifications can be combined and presented as a single icon with an associated count to indicate the number of different notifications that have been received. Further, other embodiments enable a user to quickly and efficiently deep link directly into an application associated with a particular notification.

### BACKGROUND

Many computing devices, such as desktop computing devices and phones, provide content-based notifications to users. These notifications come typically, in the form of an icon which may or may not have a number associated with it. For example, e-mail notifications may come in the form of an envelope icon with a number that represents the number of new e-mails that have been received. Likewise, weather notifications may come in the form of some type of weather-based icon (such as a cloud). Yet, the granularity at which such notifications are provided typically requires a user to perform a series of additional actions to access the particular notification and/or the application with which the notification is associated.

More generally, to date the user experience with respect to notifications such as those mentioned above and others, has fallen short of providing an efficient, streamlined and desirable user experience.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments provide notifications with respect to various communications that are visually embellished to indicate a perceived importance of the communication based upon one or more criteria. In addition, in at least some embodiments, multiple different types of notifications can be combined and presented as a single icon with an associated count to indicate the number of different notifications that have been received. Further, other embodiments enable a user to quickly and efficiently deep link directly into an application associated with a particular notification.

Other embodiments can address privacy concerns by ascertaining the user of a particular device and, based on the user, surfacing notifications that have been filtered accordingly. In this manner, various different levels of personal information can be presented, through notifications, based on the current device user.

In other embodiments, notifications can be prioritized based on a user's context and, in addition, visually prioritized to present important notifications in a more visually prominent location than other perhaps lesser important notifications. Further, notification update frequency can be modified based on a user's or device's context.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 illustrates an example operating environment in accordance with one or more embodiments.

FIG. 2 illustrates an example computing device in accordance with one or more embodiments.

FIG. 3 illustrates an example computing device in accordance with one or more embodiments.

FIG. 4 is a flow diagram that describes steps in a method in accordance with one or more embodiments.

FIG. 5 is a flow diagram that describes steps in a method in accordance with one or more embodiments.

FIG. 6 illustrates an example computing device in accordance with one or more embodiments.

FIG. 7 illustrates an example computing device in accordance with one or more embodiments.

FIG. 8 illustrates an example computing device in accordance with one or more embodiments.

FIG. 9 illustrates an example computing device in accordance with one or more embodiments.

FIG. 10 illustrates an example computing device in accordance with one or more embodiments.

FIG. 11 is a flow diagram that describes steps in a method in accordance with one or more embodiments.

FIG. 12 illustrates an example computing device in accordance with one or more embodiments.

FIG. 13 illustrates an example computing device in accordance with one or more embodiments.

FIG. 14 is a flow diagram that describes steps in a method in accordance with one or more embodiments.

FIG. 15 illustrates an example computing device in accordance with one or more embodiments.

FIG. 16 is a flow diagram that describes steps in a method in accordance with one or more embodiments.

FIG. 17 illustrates an example computing device that can be utilized to implement various embodiments described herein.

### DETAILED DESCRIPTION

Overview

Various embodiments provide notifications with respect to various communications that are visually embellished to indicate a perceived importance of the communication based upon one or more criteria. The communication is typically received by an application that resides on a computing device, such as a desktop computer, laptop computer, tablet computer, smart phone, and the like. Any suitable type of communication can be the subject of a notification as described in this document. Communications can include, by way of example and not limitation, phone calls, Voice over Internet Protocol (VoIP) calls, text messages, e-mail messages, communications associated with social network applications, communications associated with weather applications, or any other type of communication typically received by a computing device or an application that resides on the computing device.

In addition, in at least some embodiments, multiple different types of notifications can be combined and presented as a single icon with an associated count to indicate the number of different notifications that have been received. For example, notifications associated with telephone calls and VoIP calls can be combined and presented in connection with a single icon. Further, other embodiments enable a user to quickly and efficiently deep link directly into an application associated with a particular notification. Deep linking can be accomplished in any suitable way such as, by way of example and not limitation, through a touch gesture, natural user interface (NUI) gesture, an input device selection, and the like.

Other embodiments can address privacy concerns by ascertaining the user of a particular device and, based on the user, surfacing notifications that have been filtered accordingly. In this manner, various different levels of personal information can be presented, through notifications, based on the current device user.

In other embodiments, notifications can be prioritized based on a user's context and, in addition, visually prioritized to present important notifications in a more visually prominent location than other perhaps lesser important notifications. Further, notification update frequency can be modified based on a user's or device's context.

In the following discussion, an example environment is first described that is operable to employ the techniques described herein. The techniques may be employed in the example environment, as well as in other environments.

Example Environment

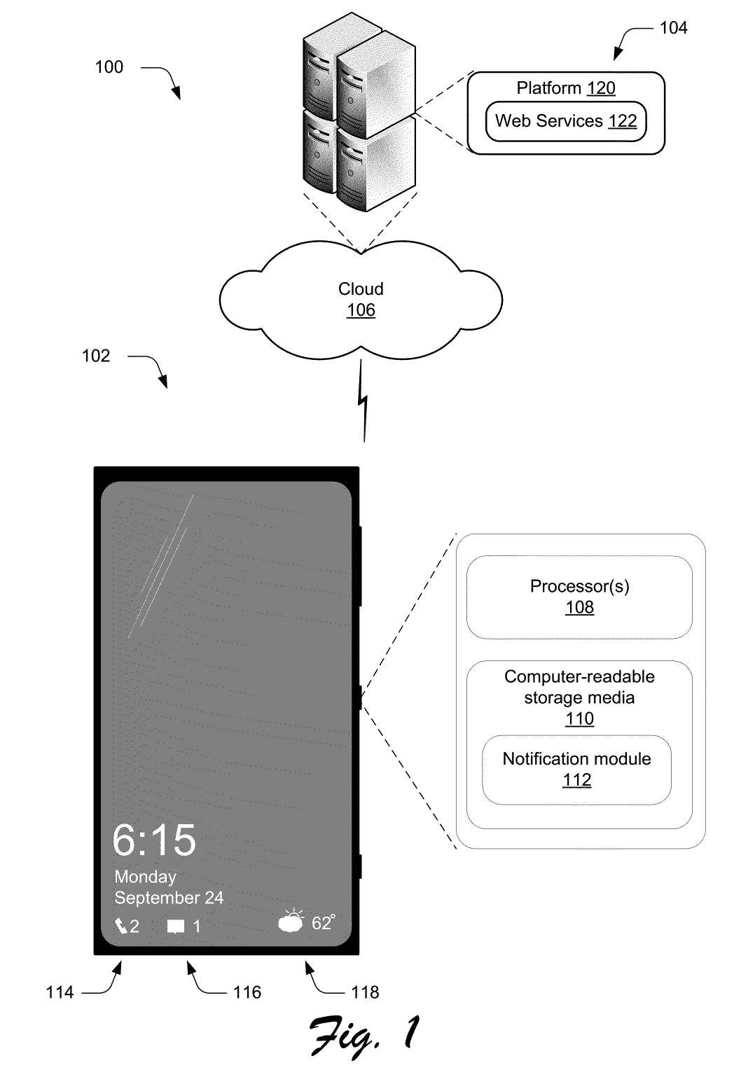

FIG. 1 illustrates an example environment 100 in an example implementation that is operable to employ the techniques described herein. The illustrated environment 100 includes a computing device 102, one or more servers 104 and a network 106 (illustrated as the “cloud”) through which the computing device 102 and the servers 104 can communicate.

In the illustrated and described example, computing device 102 includes, among other components, one or more processors 108, one or more computer readable storage media 110, and a notification module 112 that operates as described above and below with respect to notifications that are generated for various communications that are received by computing device 102. In addition, the computing device 102 includes one or more applications that can receive communications, examples of which are provided above and below. In the present example, three different notifications are shown at 114, 116, and 118 respectively.

Notification 114 is associated with calls that are received by the computing device. In this example, notification 114 includes an icon in the form of a telephone and a so-called “count”. The count has iterated to “2” to indicate that two calls have been received.

Notification 116 is associated with messages that are received by the computing device. In this example, notification 116 includes an icon in the form of a message and a count. The count has iterated to “1” to indicate that one message has been received.

Notification 118 is associated with a communication from a weather application. In this example, notification 118 includes an icon in the form of a partly sunny cloud and a temperature reading. It is to be appreciated and understood that notifications need not necessarily have a count. Rather, the notifications can include simply an icon without a count.

In practice, a “computing device” can constitute any suitable type of computing device. For example, a computing device 102 may be configured as a traditional computer (e.g., a desktop personal computer, laptop computer, and so on), a mobile station, an entertainment appliance, a set-top box communicatively coupled to a television, a wireless phone, a netbook, a game console, a handheld device, and so forth. Thus, the computing device 102 may range from full resource devices with substantial memory and processor resources (e.g., personal computers, game consoles) to a low-resource device with limited memory and/or processing resources (e.g., traditional set-top boxes, hand-held game consoles).

Servers 104 are illustrated as including a platform 120 for web services 122. Web services 122 can include any suitable type of web service. The servers 104 and their associated Web services 122 can generate communications that are provided to computing device 102 by way of network 106. When the communications are received, the communications are processed by the computing device 102 and/or an associated application executing on the computing device, and notification module 112 provides notifications as described above and below.

The platform 120 abstracts underlying functionality of hardware (e.g., servers) and software resources of the cloud and thus may act as a “cloud operating system.” For example, the platform 120 may abstract resources to enable communication between various computing devices. The platform 120 may also serve to abstract scaling of resources to provide a corresponding level of scale to encountered demand for the web services 122 that are implemented via the platform 120. A variety of other examples are also contemplated, such as load balancing of servers in a server farm, protection against malicious parties (e.g., spam, viruses, and other malware), and so on.

Thus, the cloud is included as a part of the strategy that pertains to software and hardware resources that are made available to the computing devices via the Internet or other networks.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on or by a processor (e.g., CPU or CPUs). The program code can be stored in one or more computer readable memory devices.

For example, the computing device may also include an entity (e.g., software) that causes hardware or virtual machines of the computing device to perform operations, e.g., processors, functional blocks, and so on. For example, the computing device may include a computer-readable medium that may be configured to maintain instructions that cause the computing device, and more particularly the operating system and associated hardware of the computing device to perform operations. Thus, the instructions function to configure the operating system and associated hardware to perform the operations and in this way result in transformation of the operating system and associated hardware to perform functions. The instructions may be provided by the computer-readable medium to the computing device through a variety of different configurations.

One such configuration of a computer-readable medium is a signal bearing medium and thus is configured to transmit the instructions (e.g., as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

In the discussion that follows, a section entitled “Rich Notifications” describes various types of notifications that can be provided in accordance with one or more embodiments. Following this, a section entitled “Combining Different Types of Notifications” describes how notifications of different types can be combined into a single icon in accordance with one or more embodiments. Next, a section entitled “Deep Linking to an Application from a Notification” describes how a user is able to deep link directly from a notification to an associated application in accordance with one or more embodiments. Following this, a section entitled “Surfacing Different Levels of Personal Information” describes how different levels of personal information can be surfaced on a computing device, depending on the computing device's context in accordance with one or more embodiments. Next, a section entitled “Prioritizing Notifications Based on Context” describes how notifications can be prioritized based on context, in accordance with one or more embodiments. Last, a section entitled “Example Device” describes aspects of an example device that can be utilized to implement one or more embodiments.

Having considered an example operating environment, consider now the notion of rich notifications. In the discussion that follows, various embodiments are described under separate headings. It is to be appreciated and understood that each embodiment described under its own heading can be used in connection with the other embodiments described under their associated headings. So, for example, embodiments described under the heading “Rich Notifications” can be used in connection with embodiments described under the heading “Combining Different Types of Notifications”, and so on.

Rich Notifications

As noted above, various embodiments provide notifications with respect to various communications that are visually embellished to indicate a perceived importance of the communication based upon one or more criteria. The communication is typically received by an application that resides on a computing device, such as a desktop computer, laptop computer, tablet computer, smart phone, and the like. Any suitable type of communication can be the subject of a notification as described in this document. Communications can include, by way of example and not limitation, phone calls, Voice over Internet Protocol (VoIP) calls, text messages, e-mail messages, communications associated with social network applications, communications associated with weather applications, or any other type of communication typically received by a computing device or an application that resides on the computing device.

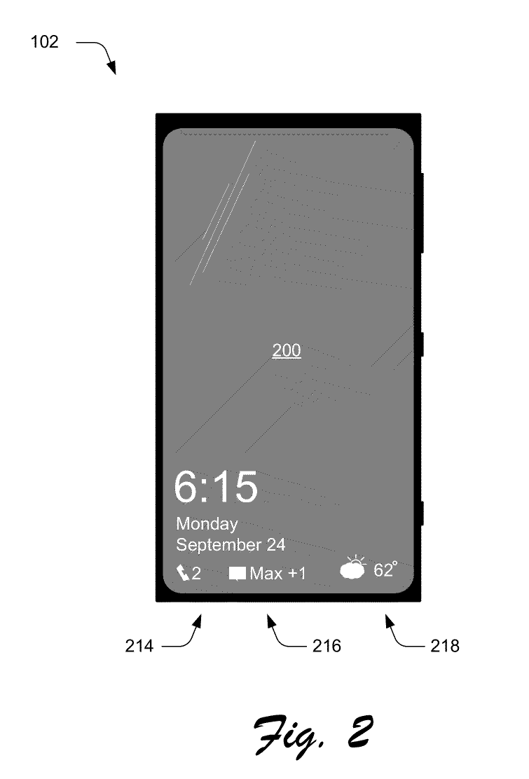

As an example, consider FIG. 2 which illustrates computing device 102 in accordance with one or more embodiments. In this example, the computing device displays a screen 200 on the computing device's display device. The screen 200 can be any suitable screen such as, by way of example and not limitation, a screen associated with and displayed by an application executing on the device, a screen associated with the device's operating system, and the like. In the examples used throughout this document, a screen in the form of a so-called “lock screen” is used. The lock screen is a user interface that is typically used by a device's operating system. Lock screens regulate immediate access to a device by having a user perform a certain action in order to receive access such as, by way of example and not limitation, entering a password, using a certain button combination, or by performing a certain gesture using the device's touchscreen.

It is to be appreciated and understood, however, that other types of screens can be utilized without departing from the spirit and scope of the claimed subject matter.

In the past, notifications (also termed “badges”), have given users a quick glance-able summary on their lock screen of information that may be of interest to the users. The notifications have done a decent job of conveying information to users, including a count associated with the notification, but have fallen short in so far as providing an ability to distinguish a more important notification from another notification. This is because all of the notifications tend to be treated the same way—that is, with an icon and a count. Furthermore, for a user to be able to identify a communication associated with a more important notification, the user first has to ascertain which notifications are more important. To do this, particularly from the device's lock screen, the user has to unlock the screen, go to the start menu, find the particular application associated with the notification, and access the application in order to act on the notification. Over time, this can have the undesirable effect of forcing the user to perform multiple actions in order to simply access an application for which a communication has been received.

Consider now computing device 102 and its associated notifications 214, 216, and 218. Notice in particular that notification 216 has been visually embellished to indicate a perceived importance of a communication. That is, the notification associated with received messages has been visually embellished to indicate the name “Max” along with a count. Specifically, various criteria can be utilized to ascertain the perceived importance of a communication. Such criteria can include, by way of example and not limitation, people who have been identified as important to the user (such as by being specifically identified by a user, appearing in the user's contact list, and the like), people with whom frequent communication takes place, people with whom recent communication has taken place, and the like.

In the illustrated and described example, notifications can be visually embellished in any suitable way. For example, in at least some embodiments, a notification can be temporarily visually embellished as by being expanded to indicate a name associated with the notification. After a period of time, e.g., a few seconds, the notification can be collapsed. Alternately or additionally, when multiple communications are perceived to be important, the notification can be visually embellished to cycle through each embellishment, e.g., each name, so that the user can identify multiple different communications that are perceived to be important.

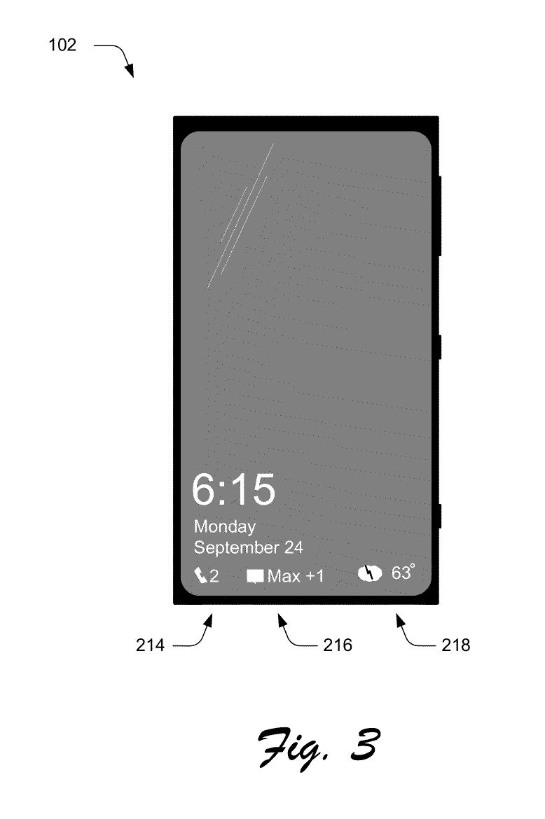

Notifications can also be visually embellished in other ways. As an example, consider FIG. 3 as compared and contrasted with FIG. 2. Particularly, notice the partly sunny icon notification 218 in FIG. 2 has been modified in FIG. 3 to indicate a thunderstorm notification. In this particular example, the computing device's weather application has received a communication associated with a change in the weather, and has caused the notification to be modified accordingly.

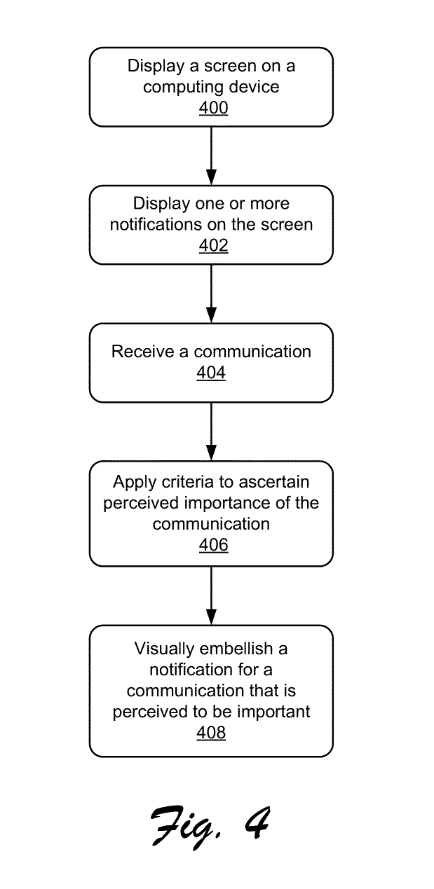

FIG. 4 is a flow diagram that describes steps in a method in accordance with one or more embodiments. The method can be performed in connection with any suitable hardware, software, firmware, or combination thereof. In at least some embodiments, aspects of the method about to be described can be performed by a suitably-configured notification module, such as that described in connection with FIG. 1. The notification module can comprise part of an application and/or part of the computing device's operating system.

Step 400 displays a screen on the computing device. Any suitable type of screen can be displayed. In at least some embodiments, the displayed screen comprises a lock screen. In at least some other embodiments, the displayed screen comprises the screen other than a lock screen. Step 402 displays one or more notifications on the screen. Examples of notifications are provided above. Step 404 receives a communication associated with an application executing on the computing device. Any suitable type of communication can be received, examples of which are provided above.

Step 406 applies criteria to ascertain a perceived importance of the communication. Any suitable type of criteria can be utilized, examples of which are provided above. Specifically, criteria can include user-defined criteria (such as identifying individuals who are important to a particular user) and criteria other than user-defined criteria. Such other criteria can include, by way of example and not limitation, criteria gleaned from an analysis of communication logs such as e-mail logs, network logs, phone call and text logs, communication history, and the like. Step 408 visually embellishes a notification for communication that is perceived to be important. Any suitable type of visual embellishment can be employed. For example, visual embellishments can include populating the notification with a name of the person from whom a communication is received. Other visual embellishments can include modifying an icon associated with the notification.

Having considered the notion of rich notifications, consider now how different types of notifications can be combined in accordance with one or more embodiments.

Combining Different Types of Notifications

In addition, in at least some embodiments, multiple different types of notifications can be combined and presented as a single icon with an associated count to indicate the number of different notifications that have been received. Typically, in the past, notifications have been associated with a single type of communication. For example, a phone call may have one type of notification, while a VoIP call may have another type notification. In some instances, users may only be concerned with receiving a notification associated with a “call”, whether that call is a phone call or a VoIP call. In these instances and others, different types of notifications can be combined and presented in connection with a single icon. So for example, notifications associated with telephone calls and VoIP calls can be combined and presented in connection with a single icon.

In at least some embodiments, the single icon can have a count that is associated with two or more different types of notifications. So, for example, if two telephone calls have been received and one VoIP call has been received, the total count that would show adjacent the icon would be “3”. Alternately or additionally, multiple different icons can be used in the same “slot” or location on the screen. Each icon can be associated with a different notification and can be visually cycled through to display the different icons at different times to convey the notification. So, for example, if two telephone calls have been received and one VoIP call has been received, a telephone call icon can be displayed in a slot, along with a count of “2”. After a period of time, the telephone call icon can be replaced in the slot with a VoIP icon, along with a count of “1”.

The above-described approach is particularly useful in connection with dual-SIM devices. Dual-SIM devices are devices that can have two SIM cards and hence, two numbers for communication. So, each number can be used for voice calls as well as text messaging. Collectively, the dual-SIM devices can receive two sets of text messages and two sets of phone calls. In accordance with the above-described principles, a single slot can be utilized to provide a notification for both numbers. In at least some embodiments, a single notification can be used for both numbers to cover both text messages and phone calls. Alternately or additionally, different notifications can be cycled in the single slot to identify text messages and phone calls in a manner similar to that described above.

In at least some embodiments, a user can define groupings associated with different notification types. That is, some users may logically associate different applications together. For example, a user may think of text messages and e-mail messages as simply different types of communication. Thus, a user may decide to group text messages and e-mail messages together for the purpose of receiving notifications. In this manner, a single slot can be utilized to provide notifications for both text messages and e-mail messages. These notifications can be cycled through in the manner described above to provide a visual embellishment for messages that are received. Alternately or additionally, groupings may be automatically defined in some particular matter. So, for example, a device manufacture may choose to group social network communications together with e-mail communications for the purpose of generating notifications in a single slot.

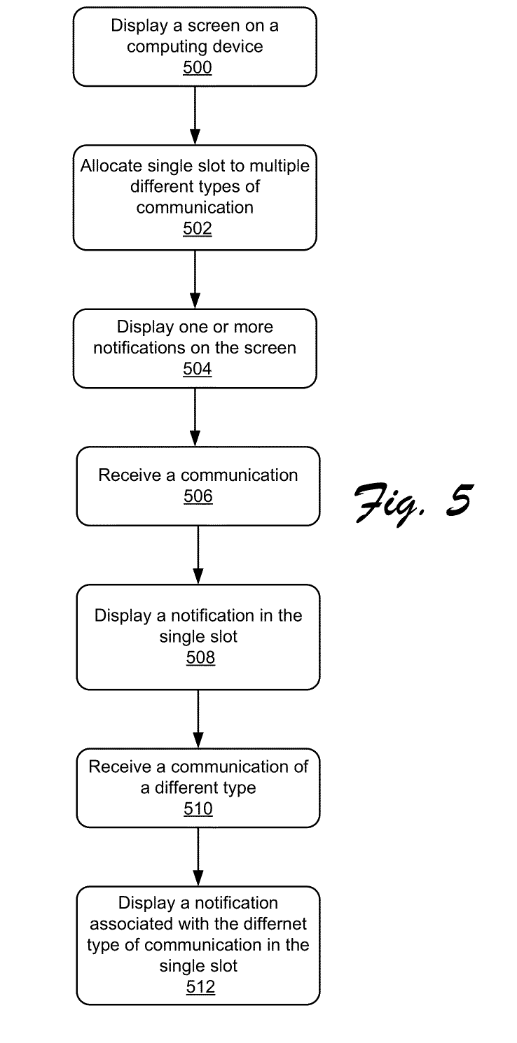

FIG. 5 is a flow diagram that describes steps in a method in accordance with one or more embodiments. The method can be performed in connection with any suitable hardware, software, firmware, or combination thereof. In at least some embodiments, aspects of the method about to be described can be performed by a suitably-configured notification module, such as that described in connection with FIG. 1. The notification module can comprise part of an application and/or part of the computing device's operating system.

Step 500 displays a screen on the computing device. Any suitable type of screen can be displayed. In at least some embodiments, the displayed screen comprises a lock screen. In at least some other embodiments, the displayed screen comprises the screen other than a lock screen. Step 502 allocates a single slot to multiple different types of communication. Examples of different types of communication are provided above. Step 504 displays one or more notifications on the screen. Examples of notifications are provided above. Step 506 receives a communication associated with an application executing on the computing device. Any suitable type of communication can be received, examples of which are provided above.

Step 508 displays a notification associated with the received communication in the single slot. Examples of how this can be done are provided above. Step 510 receives the communication of a different type. Step 512 displays a notification associated with a different type of communication in the single slot. This step can be performed in any suitable way. For example, in some instances, the computing device can alternate between steps 508 and 512 to cycle the display of different notifications associated with each type of communication. In this manner, screen real estate is conserved by using a single slot to convey notifications associated with different types of communication.

Having considered the notion of combining different types of notifications, consider now aspects of deep linking to an application from a notification.

Deep Linking to an Application from a Notification

As noted above, some embodiments enable a user to quickly and efficiently deep link directly into an application associated with a particular notification. Deep linking can be accomplished in any suitable way such as, by way of example and not limitation, through a touch gesture, natural user interface (NUI) gesture, an input device selection, and the like.

As such, deep linking as described below can mitigate the situation where, responsive to receiving a notification, the user has to unlock the screen, go to the start menu, find the particular application associated with the notification, and access the application in order to act on the notification. Thus, the user experience is quicker and more efficient.

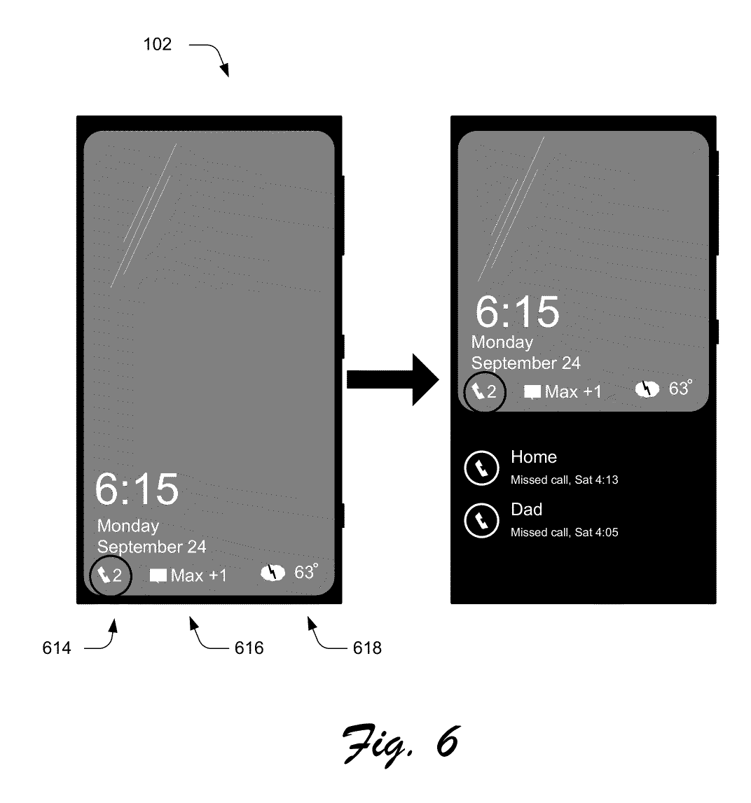

As an example, consider FIG. 6 which illustrates computing device 102 and three associated notifications 614, 616, and 618. In particular, notice that notification 614 has been touch selected by a user, as indicated by the dark circle. In this particular example, through an upward touch slide gesture, the user can expose an indication of the communications that have been received. This is illustrated in the right-most computing device which shows two missed calls, one from “Home” and one from “Dad.” Thus, through a single gesture received relative to the notification, the user can deep link to the application associated with the notifications. This alleviates the user from having to unlock their screen and perform several other actions in order to simply access the application and ascertain the context of the notifications.

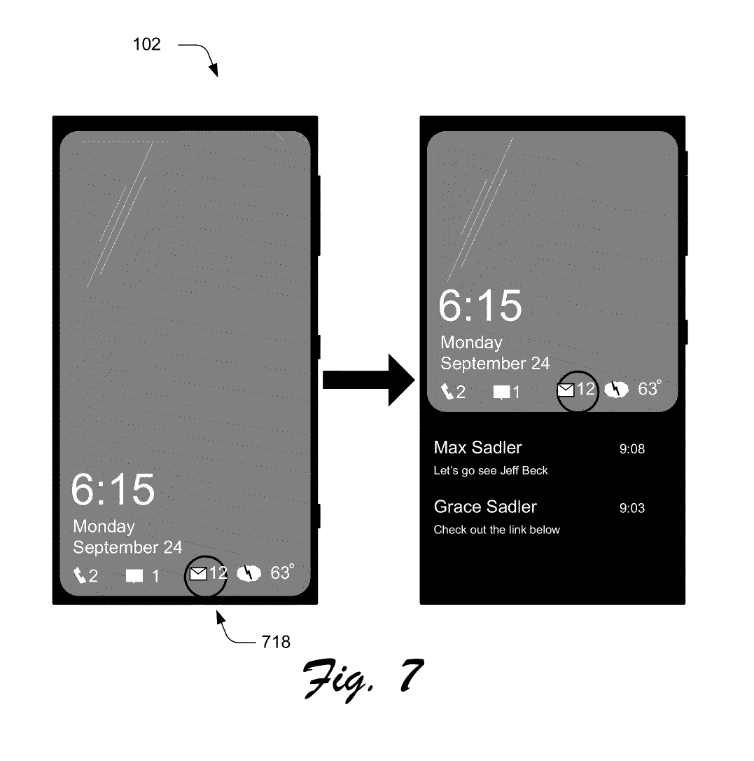

As another example, consider FIG. 7 which illustrates computing device 102 and a notification 718. Here, the user has touch selected the notification 718 and, through a single upward touch slide gesture has deep linked into the e-mail application to expose some of the recently received e-mail messages.

Any suitable techniques can be utilized to enable deep linking from a notification to an associated application. As but one example, consider the following. In at least some embodiments, each notification can include metadata or some other information, such as a URI, that indicates the application associated with the notification. This information can include an application location as well as information enabling application to be accessed. When the user touch selects a particular notification and performs an access gesture, such as the upward touch slide gesture, the notification module can utilize the metadata or URI to either launch or access a currently running application immediately.

Consider now instances in which a single slot is associated with multiple different notifications as described above. As the notifications are visually cycled through, if a user touch-selects a particular notification when it is visible, the computing device can deep link to the associated application and present content such as that described and shown in FIGS. 6 and 7. Similarly, as other notifications that reside in the single slot are made visible, touch selecting and performing the access gesture will deep link into the associated application.

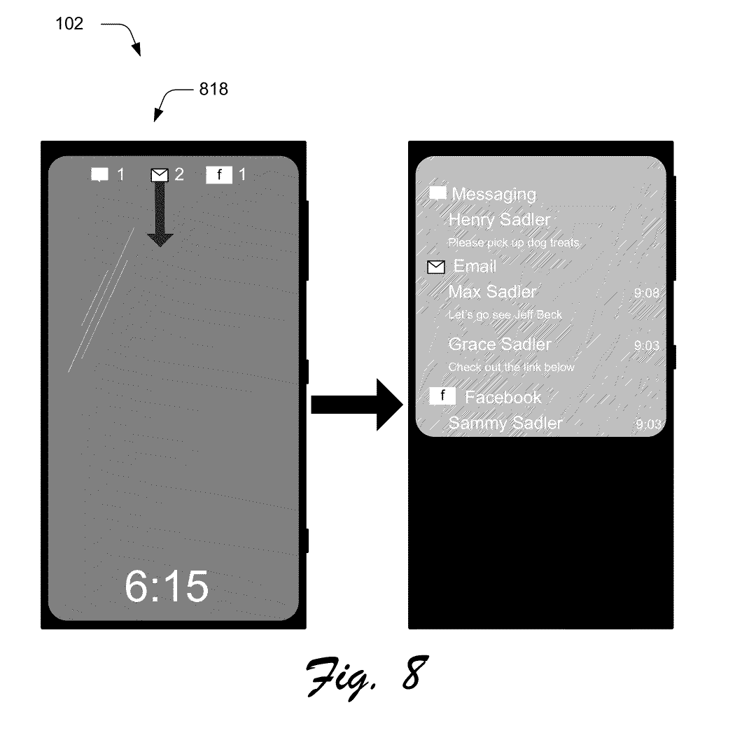

Other techniques and approaches can be utilized to promote interactive notifications for deep linking. As an example, consider FIG. 8 which illustrates computing device 102 with a number of different notifications at the top of the screen. In this example, touch-selecting an area in which the notifications reside and performing an access gesture, as indicated by the downward arrow, can expose information associated with the notifications. So, for example, notice that the notifications indicate that one text message has been received, two e-mail messages have been received, and one social networking message has been received. By touch selecting the area in which the notifications reside and performing an access gesture, the user can expose information associated with each of the messages that has been received, as indicated in the right-most illustration.

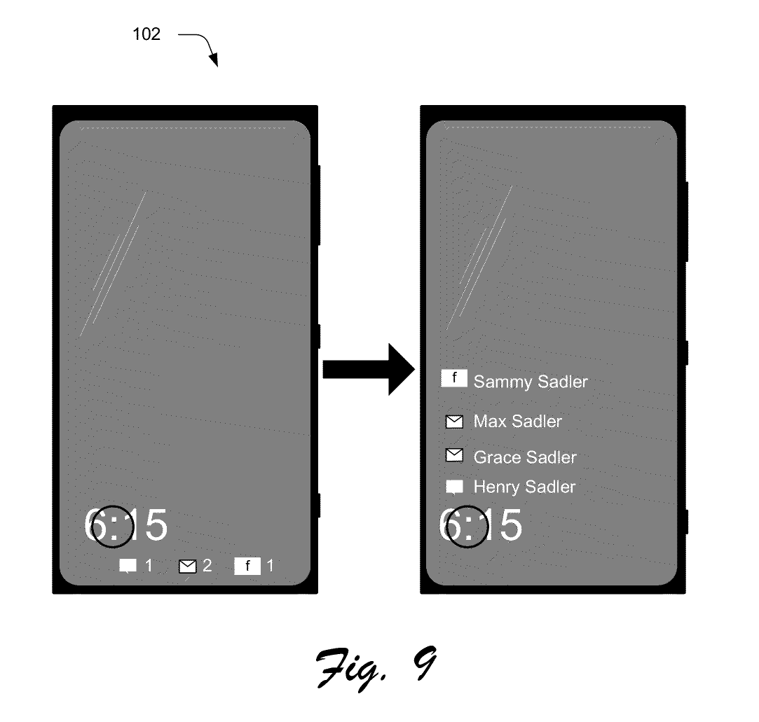

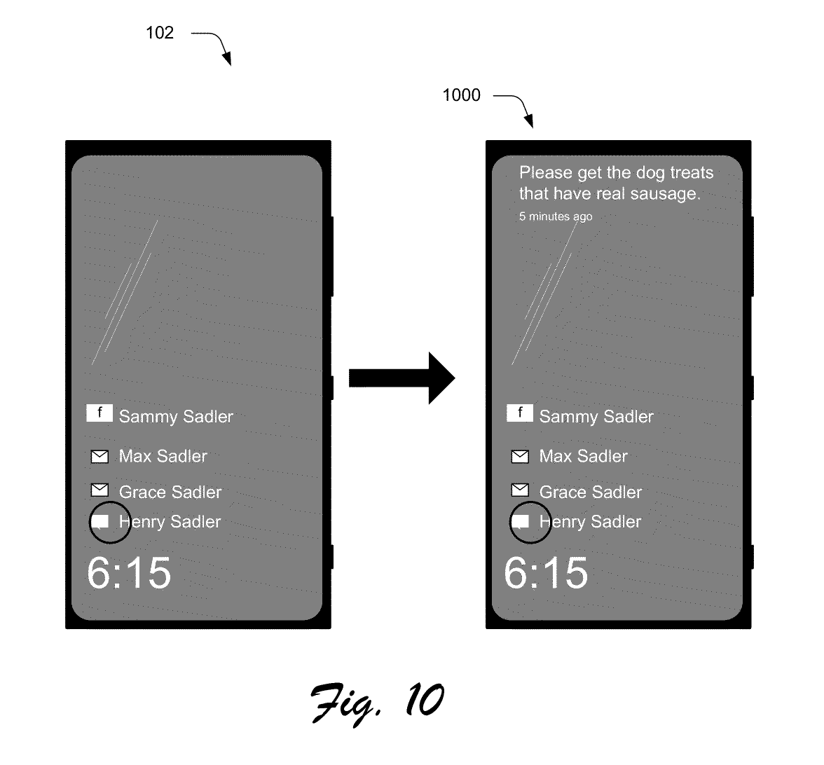

FIGS. 9 and 10 show additional embodiments that promote interactive notifications that provide deep linked previews into content associated with the notifications. For example, in FIG. 9, the user has touch selected over the time “6:15”. By doing so, the notifications are relocated and expanded out one-by-one to provide preview items. So, in this particular example, the preview items include one text message from “Henry Sadler”, two e-mail messages from “Grace Sadler” and “Max Sadler”, and one social networking message from “Sammy Sadler”.

Now, continuing on to FIG. 10, touch selecting a particular preview item can cause a deeper preview into that item which, in this example, is displayed at the top of the screen at 1000, i.e. “Please get the dog treats that have real sausage.”

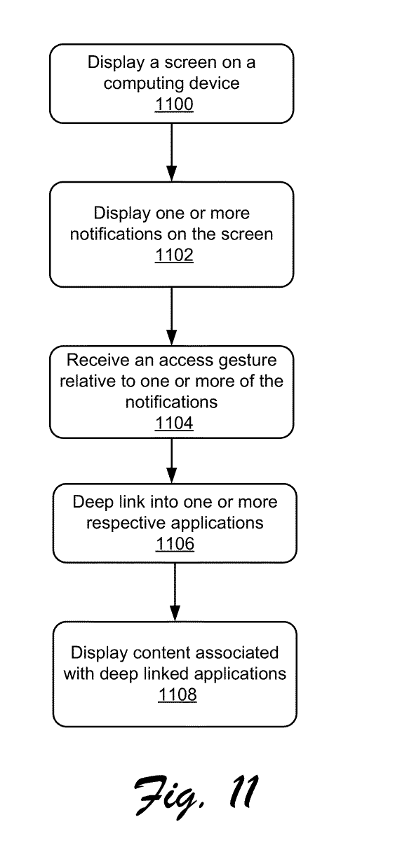

FIG. 11 is a flow diagram that describes steps in a method in accordance with one or more embodiments. The method can be performed in connection with any suitable hardware, software, firmware, or combination thereof. In at least some embodiments, aspects of the method about to be described can be performed by a suitably-configured notification module, such as that described in connection with FIG. 1. The notification module can comprise part of an application and/or part of the computing device's operating system.

Step 1100 displays a screen on a computing device. Any suitable screen can be displayed, examples of which are provided above. Step 1102 displays one or more notifications on the screen. Examples of how this can be done are provided above. Step 1104 receives an access gesture relative to one or more of the notifications. This step can be performed in any suitable way. For example, an access gesture can be received relative to a single one of the notifications. Alternately or additionally, an access gesture can be received relative to multiple notifications. Responsive to receiving the access gesture, step 1106 deep links into one or more respective application. Examples of how this can be done are provided above. Step 1108 displays content associated with the deep linked applications. This step can be performed in any suitable way. For example, in at least some embodiments and particularly those in which the access gesture is received relative to a single notification, the content that is exposed can be content associated with that particular notification's application. Alternately or additionally, in embodiments where the access gesture is received relative to multiple notifications, the content can include content associated with each notification's application. Examples of how this can be done are shown and described in connection with FIGS. 8, 9 and 10. Such content can include progressively deeper previews, such as that shown and described in connection with FIGS. 9 and 10.

Having considered notions of deep linking into respective applications, consider now a discussion of surfacing different levels of personal information in accordance with one or more embodiments.

Surfacing Different Levels of Personal Information

As noted above, other embodiments can address privacy concerns by ascertaining the user of a particular device and, based on the user, surfacing notifications that have been filtered accordingly. In this manner, various different levels of personal information can be presented, through notifications, based on the current device user. The embodiments about to be described are described in the context of a lock screen. However, as noted above, embodiments described herein can be used in connection with screens other than lock screens.

In embodiments in which notifications are provided in connection with the lock screen, the lock screen is typically the first screen that a user sees on their computing device. As such, the lock screen serves as a gateway to the user's device and information. Because the lock screen is easily accessible, it tends to be accessed frequently throughout the day by the user. In addition, because the lock screen is the first screen that is usually seen, and is easily accessible, many users can personalize the lock screen so that it has information that he or she wishes to be available at a simple glance. Because of this, however, users may have concerns that some level of the personal information should not be visible to anyone without unlocking the device. That is, personal information should not be viewable on the lock screen other than by the authorized user of the device. Thus, personalized notifications can be of concern to many users.

Consider, for example, messages that are received from a spouse or a loved one concerning a family matter or something of a sensitive nature. If someone other than the authorized user is in possession of the computing device, notifications that come in with respect to these messages may be clearly visible to someone other than the authorized user.

In accordance with one or more embodiments, the computing device is configured to detect a trigger associated with the current user of the device. Based on the particular trigger, the computing device may or may not take action to protect the authorized user's personal information. Any suitable type of trigger can be utilized.

For example, the triggers associated with who is actually holding the device may be utilized. In some instances, grip detection techniques can be utilized that employ sensors, such as capacitive sensors, to recognize grip profiles relative to the device. Specifically, in many instances an authorized user will hold the device in the same manner when they are using the device. This can enable the device to develop a grip profile associated with the authorized user. Using this grip profile, the device can then identify when the device is likely being held by someone other than the authorized user. Other triggers can include the use of other biometric profiles such as fingerprint scans, and the like.

In addition, triggers can be associated with who is in proximity to the device in a manner that suggests that they are the current user. For example, many computing devices have front-facing cameras. A front facing camera can capture a picture of the current user and compare it to a picture profile of the authorized user. Further, iris recognition can also be utilized to ascertain the current user of a particular device.

Yet, other approaches can be utilized to ascertain the current user of a computing device. For example, triggers can be associated with the way in which the computing device interacts with other computing devices. For example, the user's computing device may reside in the form of a phone, such as the ones described above. The user may also have another type of computing device such as a smart watch. The user's computing device and smart watch can be in communication with one another by way of any suitable technology such as, by way of example and not limitation, Bluetooth technology. Through a proximity analysis, the computing device can tell when the smart watch is in very close proximity so as to imply that the current user is the authorized user. When the proximity analysis indicates that the smart watch is a threshold distance away from the computing device, the device can imply that the current user is not the authorized user.

Yet other techniques can be utilized to ascertain whether the current user of the computing device is the authorized user. For example, a trigger may be associated with the way that the authorized user turns the computing device on. That is, instead of simply using a power key, the user may turn on the computing device and lock screen by using a sequence of inputs. The sequence of inputs may include a sequence of taps on the display device while the display device is off, a sequence of taps having a particular duration therebetween, a sequence of taps at different locations on the device, and the like. Thus, if the device is simply turned on using the power key, the computing device can imply that the current user is not an authorized user. However, in an event that the device is turned on using some mechanism other than the power key or a series of taps or other input in connection with the power key, then the device can imply that the current user is the authorized user.

Further, triggers may be used in connection with one another to ascertain the current user device. For example, a trigger may be a combination of analysis conducted by a front-facing camera and the grip profile utilized to hold a particular computing device.

If the particular trigger that is utilized by the computing device implies that the current user is not the authorized user, then the notification module can hide or otherwise filter personal information that might be included in the notifications. This can include information such as detailed status, personally curated information, and the like. In addition, if the current user is not the authorized user, the computing device can take measures to limit the available actions that can be performed on the device such as restricting the ability to open a “notification center” to view notifications.

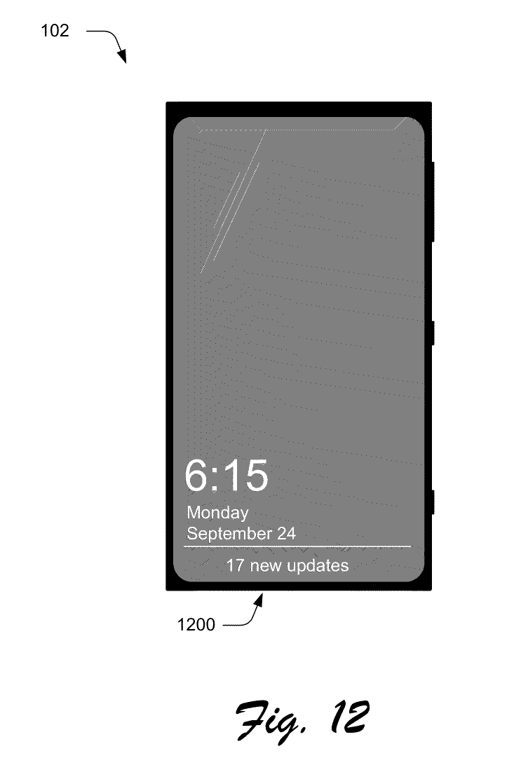

As an example, consider FIG. 12. There, the computing device 102 is shown in accordance with one embodiment. In this particular example, notice that the screen location in which notifications typically appear, indicated at 1200, includes a somewhat generic notification that simply indicates “17 new updates.” There is no personal information that has been surfaced on the device.

If, on the other hand, the particular trigger that is utilized by the computing device implies that the current user is the authorized user, then the notification module can enable the notifications to present personal information for the user.

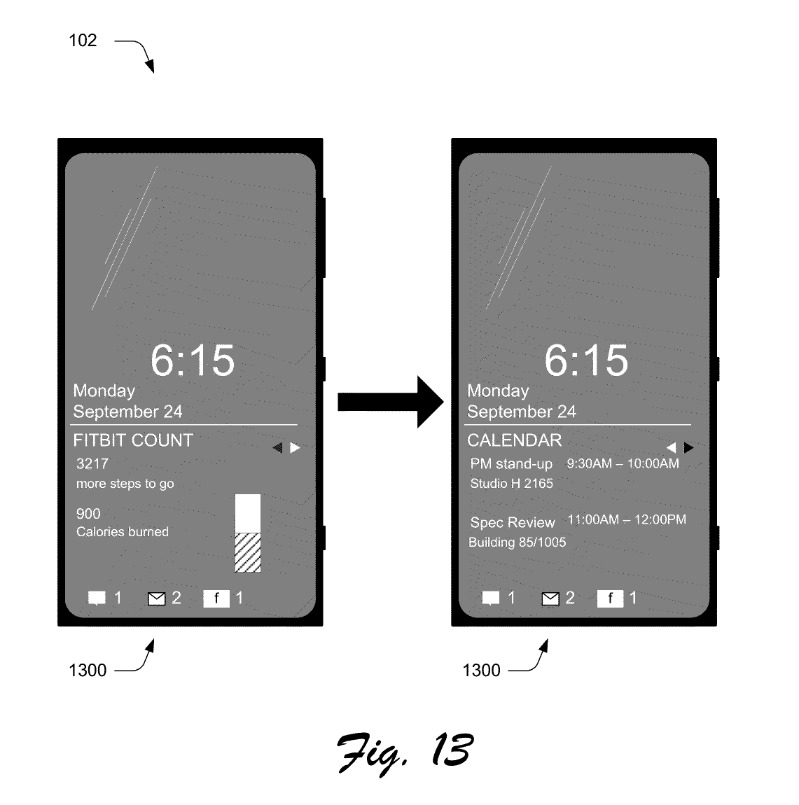

As an example, consider FIG. 13. There, the computing device 102 is shown at two different points in time. Notice that the area in which notifications occur, shown generally at 1300, includes personalized notifications including icons and associated counts, a “FITBIT COUNT” associated with the user's personal fitness application, as well as very specific calendar notifications (shown in the right-most representation which has been panned to) describing the user's scheduled meetings.

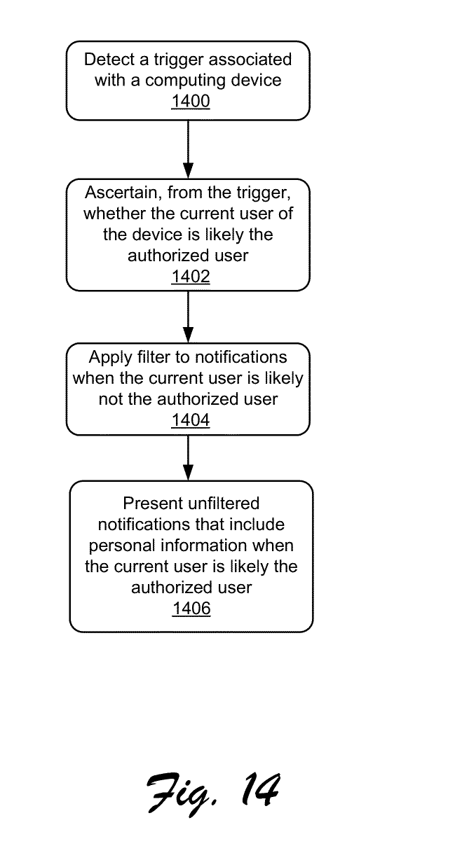

FIG. 14 is a flow diagram that describes steps in a method in accordance with one or more embodiments. The method can be performed in connection with any suitable hardware, software, firmware, or combination thereof. In at least some embodiments, aspects of the method about to be described can be performed by a suitably-configured notification module, such as that described in connection with FIG. 1. The notification module can comprise part of an application and/or part of the computing device's operating system.

Step 1400 detects a trigger associated with a computing device. Any suitable type of trigger can be utilized, examples of which are provided above. Step 1402 ascertains, from the trigger, whether the current user of the device is likely the authorized user. This step can be performed in any suitable way, examples of which are provided above. Step 1404 applies one or more filters to notifications when the current user is likely not the authorized user. An example of filtered notifications is provided in, and described in connection with FIG. 12. Step 1406 presents unfiltered notifications that include personal information when the current user is likely the authorized user. An example of unfiltered notifications is provided in, and described in connection with FIG. 13.

Having considered embodiments in which different levels of information can be surfaced depending on a device's user, consider now how notifications can be prioritized based on context in accordance with one or more embodiments.

Prioritizing Notifications Based on Context

In other embodiments, notifications can be prioritized based on a user's context and, in addition, visually prioritized to present important notifications in a more visually prominent location than other perhaps lesser important notifications. Further, notification update frequency can be modified based on a user's or device's context.

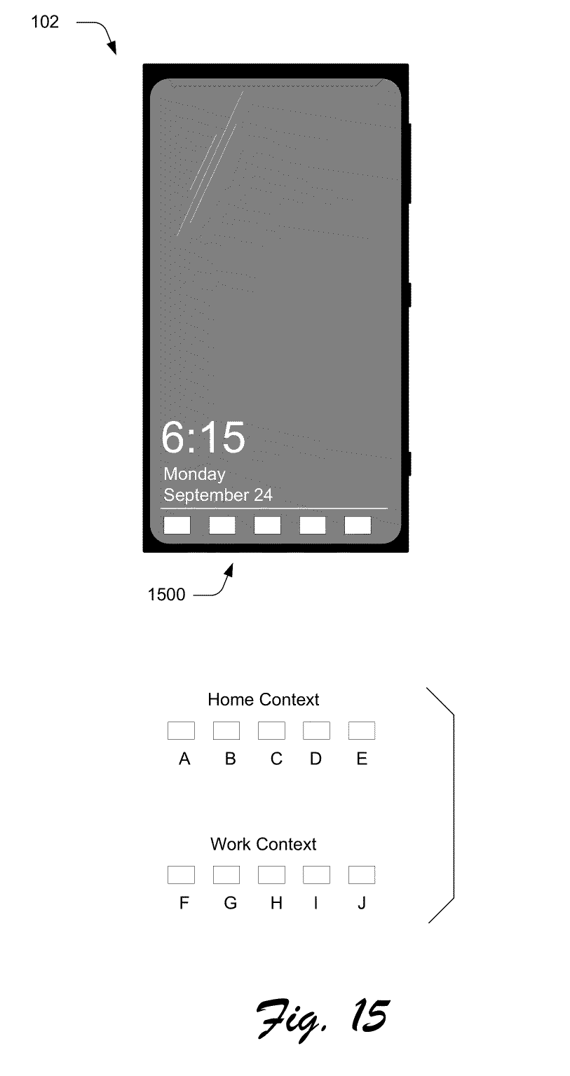

Assume that a user's computing device has space for five notification slots. As an example, consider FIG. 15. There, computing device 102 is illustrated and includes five notification slots in an area 1500 where notifications are typically surfaced. Depending on the user's context, receiving certain types of notifications may be more desirable than other notifications. For example, just below computing device 102, two different contexts are represented—“home context” and “work context”. With each context appear the five notification slots. When the user is at home, they may care more about receiving notifications that are more leisurely, such as notifications about game scores, social media, recipes, and the like. So, for example, a first set of notifications of different notification types are shown for the “home context” as “A”, “B”, “C”, “D”, and “E”. Now, assume that the user is at work. In this particular context, they may wish to see notifications that are more work-related such as notifications associated with work-related e-mail messages, calendar events, and the like. So, for example, a second set of notifications of different notification types are shown for the “work context” as “F”, “G”, “H”, “I” and “J”.

In addition to prioritizing which notifications are surfaced based on the user's context, the visual priority of the notifications can be adjusted as well. Specifically, notifications that are deemed by the user to be more important can be displayed in a visually prominent manner. For example, if the user reads from left-to-right, the most important notifications, e.g., notification “A” in the “home context” can be shown in the left-most position. Likewise, if the user reads from right-to-left, the most important notifications, e.g., notification “J” in the “work context” can be shown in the right-most position.

In the illustrated and described embodiments, the user's context can be determined based on a number of different triggers. These triggers can include any suitable triggers from which a user's or device's context can be ascertained. By way of example and not limitation, triggers can include a current location, region of interest, the current time, the user's current activity, the user's schedule, and various other things or conditions.

A user's current location can be determined in any suitable way such as, for example, using GPS coordinates associated with the user's device. A region of interest can be determined similarly except that the location can be expanded out in a predefined way. Based on a user's current location or region of interest, contextually appropriate notifications can be surfaced to the user. So, for example, a user may be in a particular region of interest where certain stores or certain services (such as GroupOn) offer special deals. In this manner, a notification slot can be associated with notifications that are received from businesses or services within or associated with a particular region of interest.

In addition, notification update frequencies can be modified depending on the particular context. For example, with respect to more important notifications, updates may occur more frequently than with notifications of lesser importance. So, for example, depending on the user's context, if one of the user's important notifications is associated with their social networking application, notifications associated with the social networking application may occur more frequently than other notifications.

With respect to triggers associated with a user's current activity, consider the following. In some instances, a user may be jogging or listening to music currently. In this particular context, certain notifications may be more relevant or important to the user than others. Specifically, if the user is jogging, they may have a physical fitness application that enables social networking with their friends. Before embarking on their jog, the user may have made a posting on their social network indicating that they were going to exercise. Knowing this, the user's friends made “like” or “comment” on the user's current activity. These notifications may be considered to be important to the user while they are exercising. As such, notifications from their physical fitness application can be prioritized into a current notification slot.

With respect to the user's schedule, consider the following. Assume that the user's schedule has a dinner appointment scheduled at a particular restaurant. The user used a particular dining application to make the reservation. In connection with the dining application, notifications can be sent such as current specials, current drink specials, and the like. These notifications can be prioritized into one of the notification slots so that the user can immediately see them.

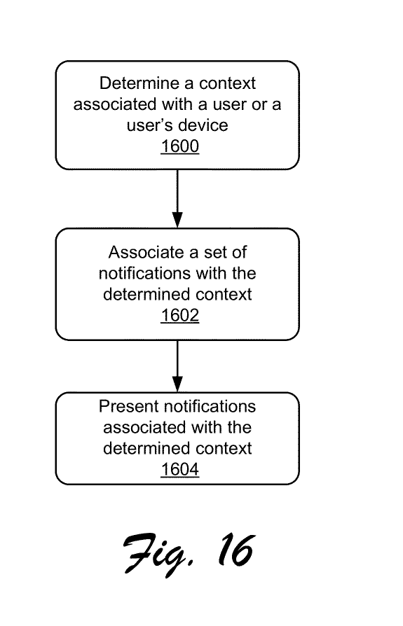

FIG. 16 is a flow diagram that describes steps in a method in accordance with one or more embodiments. The method can be performed in connection with any suitable hardware, software, firmware, or combination thereof. In at least some embodiments, aspects of the method about to be described can be performed by a suitably-configured notification module, such as that described in connection with FIG. 1. The notification module can comprise part of an application and/or part of the computing device's operating system.

Step 1600 determines a context associated with a user or user's device. Context can be determined in any suitable way, examples of which are provided above. Responsive to determining the context, step 1602 associates a set of notifications with the determined context. This step can be performed in any suitable way. For example, in at least some embodiments, individual notifications are assigned to a particular notification slot. Step 1604 presents notifications associated with the determined context. This step can be performed in any suitable way, examples of which are provided above.

When the user's context changes, a new context can be automatically determined and a new set of notifications can be associated with the new context. As such, the user's notifications can dynamically change as their context changes.

Having considered how notifications can be prioritized based on context, consider now a discussion of an example device that can be utilized to implement the embodiments described above.

Example Device

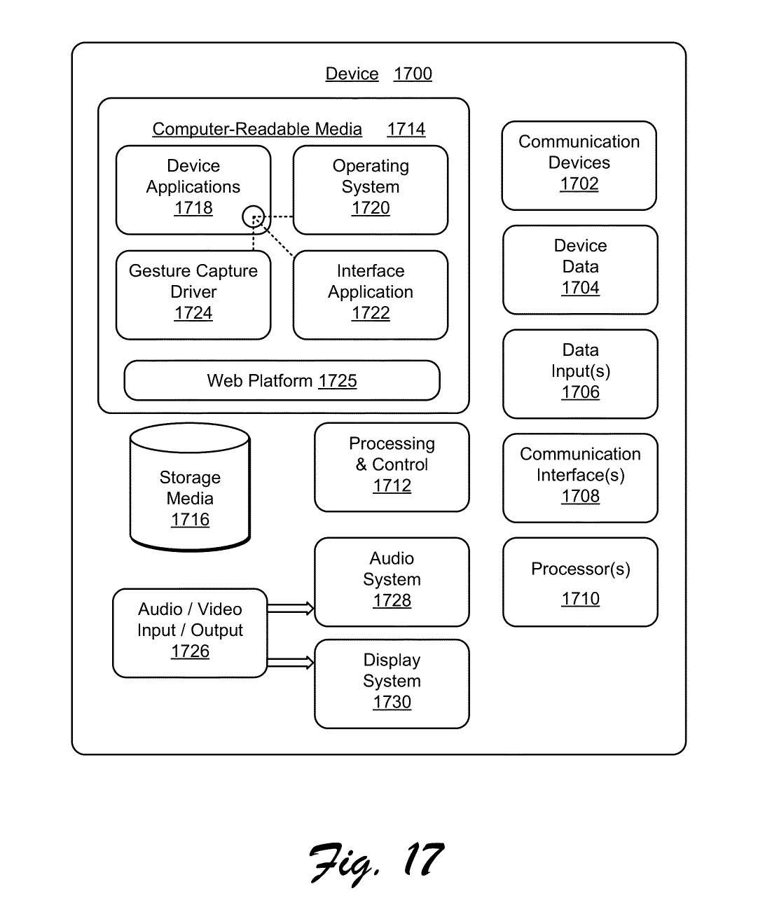

FIG. 17 illustrates various components of an example device 1700 that can be implemented as any type of computing device that can be included in a device circle. As noted above, device circles can include many different types of varied devices. As such, device 1700 constitutes but one example of a device that can be included in a device circle.

Device 1700 includes communication devices 1702 that enable wired and/or wireless communication of device data 1704 (e.g., received data, data that is being received, data scheduled for broadcast, data packets of the data, etc.). The device data 1704 or other device content can include configuration settings of the device, media content stored on the device, and/or information associated with a user of the device. Media content stored on device 1700 can include any type of audio, video, and/or image data. Device 1700 includes one or more data inputs 1706 via which any type of data, media content, and/or inputs can be received, such as user-selectable inputs, messages, music, television media content, recorded video content, and any other type of audio, video, and/or image data received from any content and/or data source.

Device 1700 also includes communication interfaces 1708 that can be implemented as any one or more of a serial and/or parallel interface, a wireless interface, any type of network interface, a modem, and as any other type of communication interface. The communication interfaces 1708 provide a connection and/or communication links between device 1700 and a communication network by which other electronic, computing, and communication devices communicate data with device 1700.

Device 1700 includes one or more processors 1710 (e.g., any of microprocessors, controllers, and the like) which process various computer-executable instructions to control the operation of device 1700 and to implement embodiments of the techniques described herein. Alternatively or in addition, device 1700 can be implemented with any one or combination of hardware, firmware, or fixed logic circuitry that is implemented in connection with processing and control circuits which are generally identified at 1712. Although not shown, device 1700 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 1700 also includes computer-readable media 1714, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 1700 can also include a mass storage media device 1716.

Computer-readable media 1714 provides data storage mechanisms to store the device data 1704, as well as various device applications 1718 and any other types of information and/or data related to operational aspects of device 1700. For example, an operating system 1720 can be maintained as a computer application with the computer-readable media 1714 and executed on processors 1710. The device applications 1718 can include a device manager (e.g., a control application, software application, signal processing and control module, code that is native to a particular device, a hardware abstraction layer for a particular device, etc.). The device applications 1718 also include any system components or modules to implement embodiments of the techniques described herein. In this example, the device applications 1718 include an interface application 1722 and a gesture capture driver 1724 that are shown as software modules and/or computer applications. The gesture capture driver 1724 is representative of software that is used to provide an interface with a device configured to capture a gesture, such as a touchscreen, track pad, camera, and so on. Alternatively or in addition, the interface application 1722 and the gesture capture driver 1724 can be implemented as hardware, software, firmware, or any combination thereof. Additionally, computer readable media 1714 can include a web platform 1725 that provides browser functionality.

Device 1700 also includes an audio and/or video input-output system 826 that provides audio data to an audio system 1728 and/or provides video data to a display system 1730. The audio system 1728 and/or the display system 1730 can include any devices that process, display, and/or otherwise render audio, video, and image data. Video signals and audio signals can be communicated from device 1700 to an audio device and/or to a display device via an RF (radio frequency) link, S-video link, composite video link, component video link, DVI (digital video interface), analog audio connection, or other similar communication link. In an embodiment, the audio system 1728 and/or the display system 1730 are implemented as external components to device 1700. Alternatively, the audio system 1728 and/or the display system 1730 are implemented as integrated components of example device 1700.

### CONCLUSION

Various embodiments provide notifications with respect to various communications that are visually embellished to indicate a perceived importance of the communication based upon one or more criteria. In addition, in at least some embodiments, multiple different types of notifications can be combined and presented as a single icon with an associated count to indicate the number of different notifications that have been received. Further, other embodiments enable a user to quickly and efficiently deep link directly into an application associated with a particular notification.

Other embodiments can address privacy concerns by ascertaining the user of a particular device and, based on the user, surfacing notifications that have been filtered accordingly. In this manner, various different levels of personal information can be presented, through notifications, based on the current device user.

In other embodiments, notifications can be prioritized based on a user's context and, in addition, visually prioritized to present important notifications in a more visually prominent location than other perhaps lesser important notifications. Further, notification update frequency can be modified based on a user's or device's context.

Although the embodiments have been described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A computer-implemented method comprising:
displaying a screen on a computing device;
displaying one or more notifications on the screen;
receiving a communication associated with an application executing on the computing device;
applying criteria to ascertain a perceived importance of the communication; and
visually embellishing a notification for communication that is perceived to be important.

2. The computer-implemented method of claim 1, wherein said screen comprises a lock screen.

3. The computer-implemented method of claim 1, wherein the criteria includes user-defined criteria.

4. The computer-implemented method of claim 1, wherein the criteria includes criteria other than user-defined criteria.

5. The computer-implemented method of claim 1, wherein visually embellishing comprises embellishing the notification with a name and a count.

6. The computer-implemented method of claim 1, wherein visually embellishing comprises temporarily visually embellishing the notification.

7. The computer-implemented method of claim 1, wherein visually embellishing comprises visually embellishing the notification to provide multiple embellishments; and cycling through each embellishment.

8. One or more computer readable storage media storing computer-readable instructions which, when executed, perform operations comprising:
allocating a single slot on a lock screen to multiple different types of communication;
receiving a first communication associated with an application executing on the computing device;
displaying a notification associated with the first communication in the single slot;
receiving a second communication of a type that is different from the first communication; and
displaying a notification associated with the second communication in the single slot.

9. The one or more computer readable storage media of claim 8, wherein said displaying a notification associated with the first communication and displaying a notification associated with the second communication comprises cycling display of the different notifications associated with the first and second communications.

10. The one or more computer readable storage media of claim 8, wherein the first communication comprises a telephone call.

11. The one or more computer readable storage media of claim 8, wherein the notification associated with the first communication and the notification associated with the second communication comprise a single icon and a count.

12. The one or more computer readable storage media of claim 8, wherein each notification comprises an icon and a count.

13. The one or more computer readable storage media of claim 8 embodied in a dual-SIM device.

14. A computing device comprising:
a display device;
one or more processors;
one or more computer readable storage media storing instructions which, when executed by the one or more processors, perform operations comprising:
displaying a lock screen on the display device;
displaying one or more notifications on the lock screen;
receiving an access gesture relative to one or more of the notifications;
responsive to receiving the access gesture, deep linking into one or more respective applications effective to display content associated with the one or more applications.

15. The computing device of claim 14, wherein the access gesture comprises a touch gesture.

16. The computing device of claim 14, wherein at least some of the notifications include an icon and a count.

17. The computing device of claim 14, wherein the deep linking alleviates the user from having to perform multiple actions to unlock the lock screen.

18. The computing device of claim 14, wherein said displaying one or more notifications comprises displaying multiple different notifications in a single slot by cycling through the multiple different notifications.

19. The computing device of claim 14, wherein said receiving an access gesture comprises receiving the access gesture relative to multiple notifications, and said deep linking comprises deep linking into multiple respective applications effective to display content from each deep linked application.

20. The computing device of claim 14, wherein said computing device is configured to enable progressively deeper previews of displayed content via touch selection.
